(19) United States
(12) Patent Application Publication
(10) Pub. No.: US 2021/0080802 A1
(43) Pub. Date: Mar. 18, 2021

(54) ELECTRO ABSORPTION MODULATING APPARATUS

(71) Applicant: Centera Photonics Inc., Hsinchu (TW)

(72) Inventors: Guan-Fu Lu, Taichung City (TW); Chen-Ying Chuang, Hsinchu County (TW)

(73) Assignee: Centera Photonics Inc., Hsinchu (TW)

(21) Appl. No.: 17/006,867

(22) Filed: Aug. 30, 2020

(30) Foreign Application Priority Data
Sep. 12, 2019 (TW) 108132940

(51) Int. Cl. G02F 1/313

(52) U.S. Cl. CPC G02F 1/3137

(57) ABSTRACT

An electro absorption modulating apparatus is provided. A plurality of electro absorption modulators are disposed on a light transmission path. A controller controls a selection driving circuit to select one of the plurality of electro absorption modulators to perform light modulation on a light beam transmitted by the light transmission path, so as to generate a light modulation signal.

### CROSS-REFERENCE TO RELATED APPLICATION

This application claims the priority benefit of Taiwan application serial no. 108132940, filed on Sep. 12, 2019. The entirety of the above-mentioned patent application is hereby incorporated by reference herein and made a part of this specification.

### BACKGROUND

### Technical Field

The invention relates to a modulating apparatus, and particularly relates to an electro absorption modulating apparatus.

### Description of Related Art

In the field of computer and communication, the demand for high transmission speed and compactness of products has become a driving force for replacing traditional electronic transmission with optical transmission. There are a variety of products and technologies in the market that serve as a mainstream or are evolving into the mainstream, and examples of such products and technologies include optical USB, silicon transceiver and silicon photonics, where data is transmitted between various devices through light.

In the aforementioned optoelectronic system, laser diode (LD) chips are usually optically coupled with a silicon waveguide. Generally, the cost of the optoelectronic system depends on packaging. Therefore, how to reduce a loss caused by the packaging yield is an important factor to improve the yield of optoelectronic products.

### SUMMARY

The invention is directed to an electro absorption modulating apparatus, which is capable of effectively reducing a loss caused by the packaging issues, and improving the fabrication yield of optoelectronic products.

The invention provides an electro absorption modulating apparatus including an optical waveguide substrate, a plurality of electro absorption modulators, a selection driving circuit and a controller. The optical waveguide substrate includes a light channel, and the light channel provides at least one light transmission path to transmit at least one light beam. The plurality of electro absorption modulators are disposed on the at least one light transmission path, and are optically coupled with the optical waveguide substrate, where each of the light transmission paths is disposed at least two electro absorption modulators. The selection driving circuit is coupled to the plurality of electro absorption modulators. The controller is coupled to the selection driving circuit, and controls the selection driving circuit to select and drive one of the plurality of electro absorption modulators corresponding to each of the light transmission paths to perform light modulation, so as to generate a corresponding light modulation signal.

In an embodiment of the invention, the plurality of electro absorption modulators on each of the light transmission paths are connected in series.

In an embodiment of the invention, the light channel has a light splitting structure providing a plurality of light splitting paths to split the light beam, and the electro absorption modulators are respectively disposed on the corresponding light splitting paths.

In an embodiment of the invention, the electro absorption modulating apparatus further includes an electronically controlled light switch, which is coupled to the controller, and is disposed at a branch point of the light splitting structure, and is controlled by the controller to switch and transmit the light beam to the light splitting path corresponding to the selected electro absorption modulator.

In an embodiment of the invention, the electronically controlled light switch includes a Mach-Zehnder light switch or a ring-shaped resonator light switch.

In an embodiment of the invention, the light splitting structure includes a Y-shaped branch pattern.

In an embodiment of the invention, the selection driving circuit includes a bias circuit, a resistor and a switch circuit. The bias circuit provides a bias voltage. The resistor is coupled between an output terminal of the bias circuit and a driving circuit return bus. The switch circuit is coupled to the controller and the driving circuit return bus. The plurality of electro absorption modulators are coupled in parallel between the bias circuit and the switch circuit, and the switch circuit is controlled by the controller to select to connect one of the plurality of electro absorption modulators to the driving circuit return bus, so as to select the electro absorption modulator used for performing light modulation on the light beam.

In an embodiment of the invention, the electro absorption modulating apparatus further includes a circuit substrate, and the selection driving circuit and the controller are disposed on the circuit substrate.

In an embodiment of the invention, the optical waveguide substrate is disposed on the circuit substrate, and the plurality of electro absorption modulators are connected to the selection driving circuit and the controller through wire bonding or through-silicon vias.

In an embodiment of the invention, each of the electro absorption modulators is partially overlapped with the optical waveguide substrate or embedded into the optical waveguide substrate to optically couple to the optical waveguide substrate.

Based on the above description, in the embodiment of the invention, by configuring a plurality of electro absorption modulators on the light transmission paths, the controller may control the selection driving circuit to select one of the electro absorption modulators to perform light modulation on the light beam transmitted by the light transmission path, so as to generate a light modulation signal. In this way, when a part of the electro absorption modulators cannot be used, the other electro absorption modulators may be used to perform the light modulation, so as to effectively reduce the loss caused by the packaging yield, and improve the yield of optoelectronic products.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electro absorption modulating apparatus according to an embodiment of the invention.

FIG. 2A is a schematic diagram of optical coupling of an electro absorption modulator and an optical waveguide substrate according to an embodiment of the invention.

FIG. 2B is a schematic diagram of optical coupling of the electro absorption modulator and the optical waveguide substrate according to another embodiment of the invention.

FIG. 3 is a schematic diagram of electro absorption modulators and the optical waveguide substrate according to an embodiment of the invention.

FIG. 4 is a schematic diagram of connection of the electro absorption modulators and a circuit substrate according to an embodiment of the invention.

FIG. 5 is a schematic diagram of connection of the electro absorption modulators and the circuit substrate according to another embodiment of the invention.

FIG. 6 is a schematic diagram of a selection driving circuit according to an embodiment of the invention.

FIG. 7 is a schematic diagram of configuration of the electro absorption modulators according to an embodiment of the invention.

FIG. 8 is a schematic diagram of configuration of the electro absorption modulators according to another embodiment of the invention.

### DESCRIPTION OF THE EMBODIMENTS

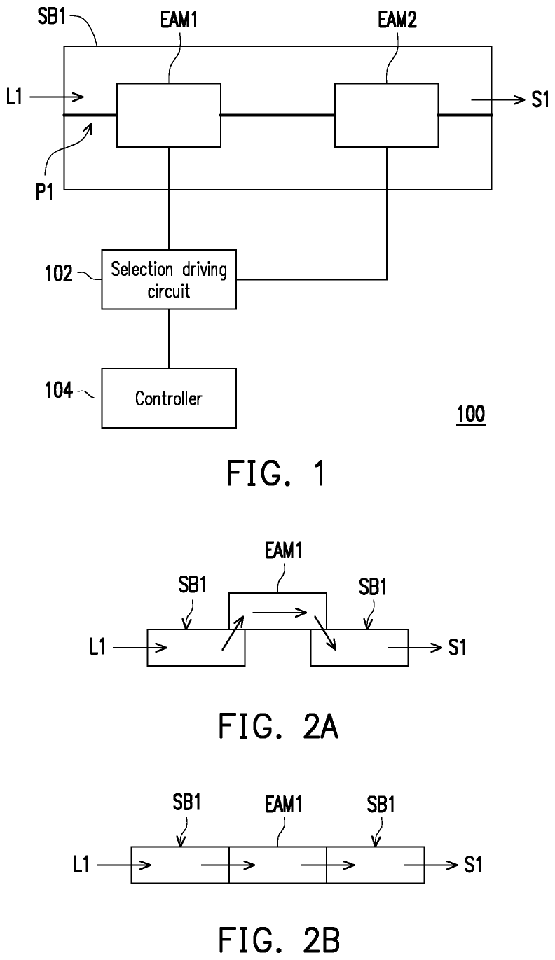

Referring to FIG. 1, FIG. 1 is a schematic diagram of an electro absorption modulating apparatus according to an embodiment of the invention. The electro absorption modulating apparatus 100 may include an optical waveguide substrate SB1, electro absorption modulators EAM1 and EAM2, a selection driving circuit 102 and a controller 104. The optical waveguide substrate SB1 may be a silicon dioxide substrate, a III-V semiconductor compound substrate, a silicon substrate on insulator, a polymer substrate or a glass substrate, but the invention is not limited thereto. The optical waveguide substrate SB1 may include a light channel P1 composed of optical waveguides, and the light channel P1 is configured to provide a light transmission path used for transmitting a light beam L1. The electro absorption modulators EAM1 and EAM2 may be bonded to the optical waveguide substrate SB1 in a die-to-wafer bonding process, for example, bonded to the optical waveguide substrate SB1 in a flip chip bonding manner. In the embodiment, the electro absorption modulators EAM1 and EAM2 are configured on the light transmission path in a serial manner.

The selection driving circuit 102 is coupled to the electro absorption modulators EAM1 and EAM2 and the controller 104, and the controller 104 may control the selection driving circuit 102 to select and drive the electro absorption modulator EAM1 or EAM2 corresponding to the light transmission path, performing light modulation on the light beam L1, so as to generate a light modulation signal S1. The electro absorption modulators EAM1 and EAM2 may be partially overlapped with the optical waveguide substrate SB1 or embedded into the optical waveguide substrate SB1 to optically couple to the optical waveguide substrate SB1. Taking the electro absorption modulator EAM1 as an example, as shown in FIG. 2A, the electro absorption modulator EAM1 may be partially overlapped with the optical waveguide substrate SB1 to optically couple with the same, and the so-called partial overlapping refers to that the electro absorption modulator EAM1 is disposed on or under the light channel of the optical waveguide substrate, and the electro absorption modulator EAM1 is partially overlapped with the light channel in the direction vertical to the light channel, and the light beam or light signal enters the electro absorption modulator EAM1 from the light channel or enters the light channel from the electro absorption modulator EAM1 at the overlapping portion in an inter-layer conduction manner, for example, evanescent coupling, or as shown in FIG. 2B, the optical coupling is implemented by embedding the electro absorption modulator EAM1 into the optical waveguide substrate SB1, and the so-called embedding refers to that the electro absorption modulator EAM1 is placed approximately at the direction parallel to the light channel, and the light beam or light signal enters one end of the electro absorption modulator EAM1 from one end of the light channel, or enters one end of the light channel from one end of the electro absorption modulator EAM1, and the light channel is substantially parallel with a light emitting surface or a light incident surface of the electro absorption modulator, and in the case the selection driving circuit 102 selects the electro absorption modulator EAM1 to perform the light modulation, the light beam L1 coming from the optical waveguide substrate SB1 is subjected to the light modulation of the electro absorption modulator EAM1 to generate the light modulation signal S1, and the light modulation signal S1 again enters the optical waveguide substrate SB1. Moreover, for the electro absorption modulator EAM2 is not selected, it will not perform light modulation on the light modulation signal S1, but provide the function of light transmission.

By configuring the electro absorption modulators EAM1 and EAM2 on the light transmission path, and using the selection driving circuit 102 to select the electro absorption modulator EAM1 or EAM2 to perform light modulation on the light beam L1, the light modulation function can be maintained even if one of the electro absorption modulators EAM1 and EAM2 fails, because the other one will be selected to perform the light modulation, so as to effectively reduce the loss caused by the packaging issues and improve the yield of optoelectronic products.

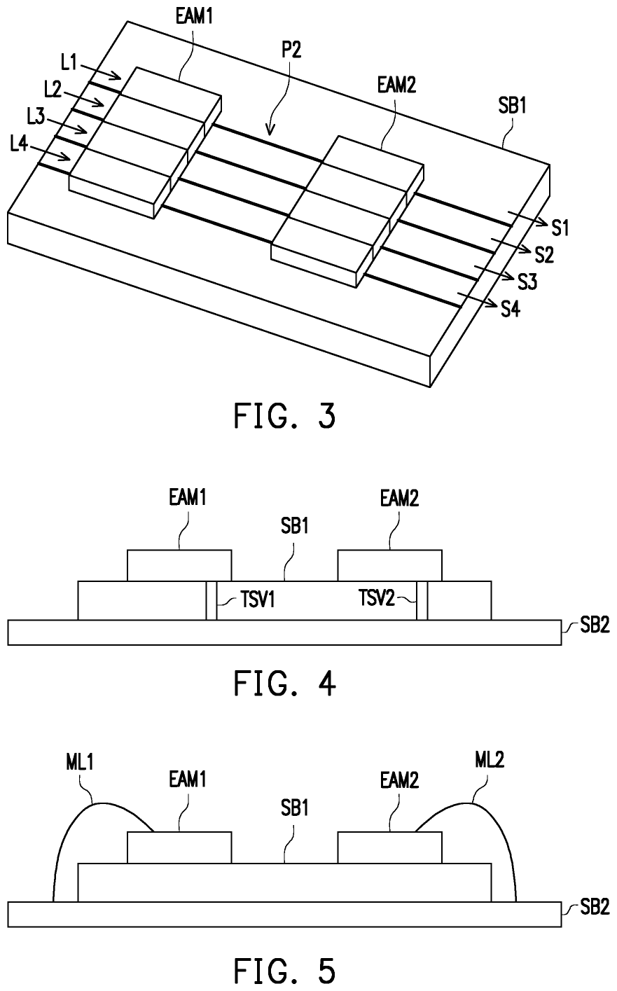

It should be noted that the electro absorption modulating apparatus 100 of the embodiment only includes two electro absorption modulators EAM1 and EAM2, but the number of the electro absorption modulators is not limited thereto, and in other embodiments, more electro absorption modulators may be connected in series on the light transmission path. Moreover, the light channel P1 is not limited to only one light transmission path, but may include more light transmission paths. As shown in FIG. 3, a light channel P2 of the optical waveguide substrate SB1 may include four light transmission paths, and each of them may be configured with two electro absorption modulators EAM1 and EAM2 as that shown in FIG. 1, and the four light transmission paths may be respectively used for transmitting light beams L1-L4, and the corresponding electro absorption modulator EAM1 or EAM2 may be used to perform the light modulation to generate light modulation signals S1-S4.

The selection driving circuit 102 and the controller 104 of the electro absorption modulating apparatus 100 may be disposed on a circuit substrate, and the circuit substrate is, for example, a printed circuit board. As shown in FIG. 4, the optical waveguide substrate SB1 may be disposed on a circuit substrate SB2, and the electro absorption modulators EAM1 and EAM2 may be connected to the selection driving circuit 102 and the controller 104 on the circuit substrate SB2 through silicon through vias TSV1 and TSV2, but the invention is not limited thereto. For example, in an embodiment of FIG. 5, the electro absorption modulators EAM1 and EAM2 may also be connected to the selection driving circuit 102 and the controller 104 on the circuit substrate SB2 through bonding wires ML1 and ML2.

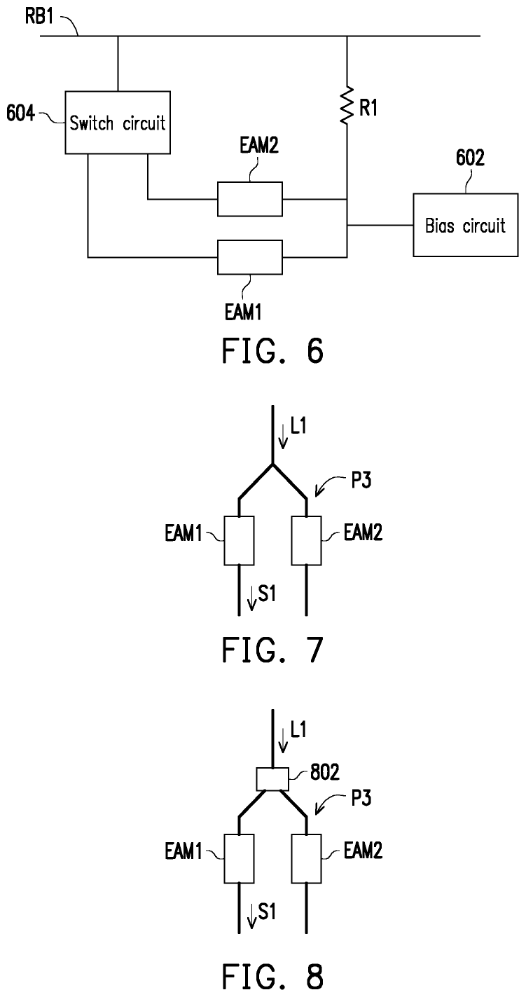

FIG. 6 is a schematic diagram of the selection driving circuit 102 according to an embodiment of the invention. Further, implementation of the selection driving circuit 102 is shown in FIG. 6, and the selection driving circuit 102 may include a bias circuit 602, a resistor R1 and a switch circuit 604, where the electro absorption modulators EAM1 and EAM2 are electrically coupled in parallel between the bias circuit 602 and the switch circuit 604. The switch circuit 604 is further electrically coupled to a driving circuit return bus RB1, and the resistor R1 is electrically coupled between an output terminal of the bias circuit 602 and the driving circuit return bus RB1. The bias circuit 602 is used to generate a bias voltage to provide the voltage required by the electro absorption modulators EAM1 and EAM2 for performing light modulation. The controller 104 controls the switch circuit 604 to select one of the electro absorption modulators EAM1 and EAM2 for coupling to the driving circuit return bus RB1, so as to perform light modulation on the light beam L1. For example, when the electro absorption modulator EAM1 is selected to perform the light modulation, the controller 104 controls the switch circuit 604 to select the electro absorption modulator EAM1 for coupling to the driving circuit return bus RB1.

It should be noted that in the aforementioned embodiment, the situation that the electro absorption modulators EAM1 and EAM2 are connected in series on the light transmission path is taken as an example for description, but in some embodiments, the electro absorption modulators EAM1 and EAM2 may also be configured in parallel. For example, FIG. 7 is a schematic diagram of configuration of the electro absorption modulators according to an embodiment of the invention. In the embodiment, a light channel P3 of the optical waveguide substrate SB1 is a light splitting structure. As shown in FIG. 7, the light channel P3 may be a Y-shaped branch structure. The Y-shaped branch structure may provide two light splitting paths to split the light beam L1. Namely, the light transmission path may include two light splitting paths, which may split the light beam L1 into two light beams.

The electro absorption modulators EAM1 and EAM2 may be respectively configured on the two light splitting paths of the Y-shaped branch pattern, and the selection driving circuit 102 selects one of EAM1 or EAM2 to perform light modulation on the light beam, generating the light modulation signal S1. Taking the embodiment of FIG. 7 as an example, the selection driving circuit 102 selects the electro absorption modulator EAM1 to perform the light modulation on the light beam on the light splitting path to generate the light modulation signal S1. In other embodiments, the electro absorption modulator EAM2 may be selected to perform the light modulation on the light beam on the light splitting path to generate the light modulation signal S1. Similarly, by respectively configuring the electro absorption modulators EAM1 and EAM2 on the two light splitting paths, when one of the electro absorption modulators EAM1 and EAM2 fails, the other one of the electro absorption modulators EAM1 and EAM2 may be used to perform the light modulation, so as to effectively reduce the loss caused by the packaging issues, and improve the yield of optoelectronic products.

Moreover, the electro absorption modulating apparatus of the embodiment only includes two electro absorption modulators EAM1 and EAM2, but the number of the electro absorption modulators is not limited thereto, and in other embodiments, more electro absorption modulators connected in series may be disposed on the light splitting path. Moreover, the light channel P3 is not limited to only two light splitting paths, and more light transmitting paths may be provided to have a plurality of light splitting paths accordingly, and the plural electro absorption modulators will be configured on each of the light splitting paths correspondingly.

FIG. 8 is a schematic diagram of configuration of the electro absorption modulators according to another embodiment of the invention. A difference between the present embodiment and the embodiment of FIG. 7 is that the embodiment of FIG. 8 further includes an electronically controlled light switch 802, which may be disposed at a branch point of the light splitting structure. The electronically controlled light switch 802 may be a Mach-Zehnder light switch or a ring-shaped resonator light switch, which is electrically coupled to the controller 104, and is controlled by the controller 104 to switch and transmit the light beam L1 to the light splitting path corresponding to the selected electro absorption modulator, so that the light intensity of the light beam on the light splitting path could be substantially maintained to avoid quality decreasing of optical communication. For example, in the embodiment of FIG. 8, if the electro absorption modulator EAM1 is selected, the controller 104 may control the electronically controlled light switch 802 to direct and transmit the light beam L1 to the light path corresponding to the electro absorption modulator EAM1 rather than EAM2 to perform the light modulation, so that the light modulation signal S1 will be generated with full light intensity to ensure the quality of optical communication.

In summary, in the embodiments of the invention, by configuring a plurality of electro absorption modulators on the light transmission paths, the controller may control the selection driving circuit to select one of the electro absorption modulators to perform light modulation on the light beam transmitted by the light transmission path, so as to generate a light modulation signal. In this way, when a part of the electro absorption modulators cannot be used, the other electro absorption modulators may be used to perform the light modulation, so as to effectively reduce the loss caused by the packaging yield, and improve the yield of optoelectronic products.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An electro absorption modulating apparatus, comprising:
an optical waveguide substrate, comprising a light channel, wherein the light channel provides at least one light transmission path to transmit at least one light beam;
a plurality of electro absorption modulators, disposed on the at least one light transmission path, and optically coupled with the optical waveguide substrate, wherein each of the light transmission paths is configured with at least two electro absorption modulators;
a selection driving circuit, directly coupled to the electro absorption modulators; and
a controller, coupled to the selection driving circuit, and controlling the selection driving circuit to select and drive one of the plurality of electro absorption modulators corresponding to each of the light transmission paths to perform light modulation, so as to generate a corresponding light modulation signal.

2. The electro absorption modulating apparatus as claimed in claim 1, wherein the plurality of electro absorption modulators on each of the light transmission paths are connected in series.

3. The electro absorption modulating apparatus as claimed in claim 1, wherein the light channel has a light splitting structure providing a plurality of light splitting paths to split the light beam, and the electro absorption modulators are respectively disposed on the corresponding light splitting paths.

4. The electro absorption modulating apparatus as claimed in claim 3, further comprising:
an electronically controlled light switch, coupled to the controller, disposed at a branch point of the light splitting structure, and controlled by the controller to switch and transmit the light beam to the light splitting path corresponding to the selected electro absorption modulator.

5. The electro absorption modulating apparatus as claimed in claim 4, wherein the electronically controlled light switch comprises a Mach-Zehnder light switch or a ring-shaped resonator light switch.

6. The electro absorption modulating apparatus as claimed in claim 3, wherein the light splitting structure comprises a Y-shaped branch pattern.

7. The electro absorption modulating apparatus as claimed in claim 1, wherein the selection driving circuit comprises:
a bias circuit, providing a bias voltage;
a resistor, coupled between an output terminal of the bias circuit and a driving circuit return bus; and
a switch circuit, coupled to the controller and the driving circuit return bus, the electro absorption modulators being coupled in parallel between the bias circuit and the switch circuit, and the switch circuit being controlled by the controller to select to connect one of the electro absorption modulators to the driving circuit return bus, so as to select the electro absorption modulator used for performing light modulation on the light beam.

8. The electro absorption modulating apparatus as claimed in claim 1, further comprising:
a circuit substrate, the selection driving circuit and the controller being disposed on the circuit substrate.

9. The electro absorption modulating apparatus as claimed in claim 8, wherein the optical waveguide substrate is disposed on the circuit substrate, and the electro absorption modulators are connected to the selection driving circuit and the controller through wire bonding or through-silicon vias.

10. The electro absorption modulating apparatus as claimed in claim 1, wherein each of the electro absorption modulators is partially overlapped with the optical waveguide substrate or embedded into the optical waveguide substrate to optically couple to the optical waveguide substrate.
